(19) United States
(12) Patent Application Publication
(10) Pub. No.: US 2006/0072806 A1
(43) Pub. Date: Apr. 6, 2006

(54) METHOD FOR INSPECTING PHOTOMASK

(76) Inventor: Hung-Shing Lin, Taichung City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/908,578

(22) Filed: May 18, 2005

(30) Foreign Application Priority Data
Sep. 29, 2004 (TW) 93129348

(51) Int. Cl. G06K 9/00

(52) U.S. Cl. 382/144

(57) ABSTRACT

A method for inspecting a photomask is described. Photomask patterns are transferred onto a wafer, and an abnormal photomask pattern is searched out and coordinates thereof are acquired. A photomask region containing the abnormal photomask pattern is defined, and coordinates thereof are acquired. Next, a shot on the wafer is arbitrarily selected, and coordinates of a wafer region in the shot corresponding to the photomask region are acquired. Further, a position of a possible abnormal wafer pattern in the shot corresponding to the abnormal phoromask pattern is calculated on the basis of coordinates of the abnormal photomask pattern, photomask region, and wafer region. Based on the above coordinates, coordinates of the position of a possible abnormal wafer pattern in the shot corresponding to the abnormal phoromask pattern are acquired. Finally, it is determined whether the abnormal wafer pattern indeed exists at the above position in the shot.

### CROSS-REFERENCE TO RELATED APPLICATION

This application claims the priority benefit of Taiwan application serial no. 93129348, filed on Sep. 29, 2004. All disclosure of the Taiwan application is incorporated herein by reference.

### BACKGROUND OF THE INVENTION

1. Field of the Invention

The present invention relates to a method for inspecting semiconductor fabricating apparatus, and more particularly to a method for inspecting a photomask.

2. Description of the Related Art

Photomasks are widely used as important apparatus in semiconductor fabricating processes, which is because, in part, that a single photomask is usually used for making a large number of identical IC products. If there is any defect in the pattern of the photomask, the defect will be transferred onto the patterns of all IC products made by using the photomask, which will cause all of the IC products to be defective.

In the course of the development of semiconductor fabricating processes, wiring width of IC products is getting smaller. Thus, it is critical for semiconductor manufacturers to control the quality of the photomasks used in the processes. For such quality control, it is also a challenge for photomask providers to provide appropriate methods or tools for inspecting photomasks. At present, mask inspection tools and the relevant simulation methods are often used in industries to inspect abnormal patterns on the photomasks.

However, mask inspection tools are often too expansive to be used by semiconductor manufacturers due to the use of electron beams or extreme ultraviolet (EUV) in the mask inspection tools. Thus, the semiconductor manufacturers, while in doubt about the quality of the photomasks, often rely on inspection results provided by the mask providers. On the other hand, the simulation methods for inspecting photomasks are disadvantageous because of relatively low accuracy.

### SUMMARY OF THE INVENTION

Accordingly, the present invention is to provide a method for inspecting photomask, which can be used to reduce the cost of mask inspection and thus is compatiable with existing facilities of semiconductor manufacturers, so that the semiconductor manufacturers are feasible to carry out the inspection by themselves.

The present invention is also to provide a method for inspecting photomask to enhance the accuracy of mask inspection and to increase yield of production.

To achieve the above and other objectives, the invention provides a method of inspecting photomask for searching out an abnormal photomask pattern and then determining whether a corresponding abnormal pattern exists on the wafer. Patterns of the photomask are first transferred onto the wafer, and then, an abnormal pattern is searched out on the photomask and the coordinates thereof are acquired. Next, a photomask region including the abnormal pattern is defined, and the coordinates thereof are acquired. Further, a shot on the wafer is then arbitrarily selected, and the coordinates of a wafer region in the shot corresponding to the photomask region are acquired. Coordinates of the position of a possible abnormal pattern in the shot corresponding to the abnormal photomask pattern are calculated on the basis of the coordinates of the abnormal photomask pattern, the photomask region, and the wafer region. Finally, it is determined whether an abnormal wafer pattern corresponding to the abnormal photomask pattern exists at the foregoing position in the shot.

This invention provides another method of inspecting photomask for searching out an abnormal wafer pattern and then determining whether a corresponding abnormal pattern exists on the photomask. Patterns of the photomask are first transferred onto the wafer, and then, an abnormal pattern appears at the same relative position on a plurality of shots is searched out. Next, the coordinates of the abnormal pattern are acquired, and then, the wafer region containing the abnormal pattern is defined and the coordinates thereof are acquired. Further, the coordinates of the photomask region corresponding to the wafer region are acquired. Coordinates of a position of possible abnormal photomask pattern corresponding to the abnormal wafer pattern are calculated on the basis of the coordinates of the abnormal wafer pattern, the wafer region, and the photomask region. Finally, it is determined whether an abnormal photomask pattern corresponding to the abnormal wafer pattern exists at the foregoing position.

In this invention, since the wafer pattern that is transferred from the photomask is used for inspecting the photomask, near ultraviolet photomask inspecting tools, which are regularly used in semiconductor plants, can be used for searching out the abnormal photomask patterns. Thus, the methods of this invention can be applied in semiconductor plants for photomask inspection and can be used to significantly reduce cost of the photomask inspecation.

It is to be understood that both the foregoing general description and the following detailed description are exemplary, and are intended to provide further explanation of the invention as claimed.

### BRIEF DESCRIPTION OF THE DRAWINGS

FIG. 1 is a flowchart showing a method for inspecting a photomask according to a first embodiment of this invention.

FIGS. 2A and 2B are sketches illustrating an example of the method for inspecting a photomask according to the first embodiment of this invention.

FIG. 3 is a flowchart showing a method for inspecting a photomask according to a second embodiment of this invention.

FIGS. 4A and 4B are sketches illustrating an example of the method for inspecting a photomask according to the first embodiment of this invention.

### DESCRIPTION OF THE PREFERRED EMBODIMENTS

### First Embodiment

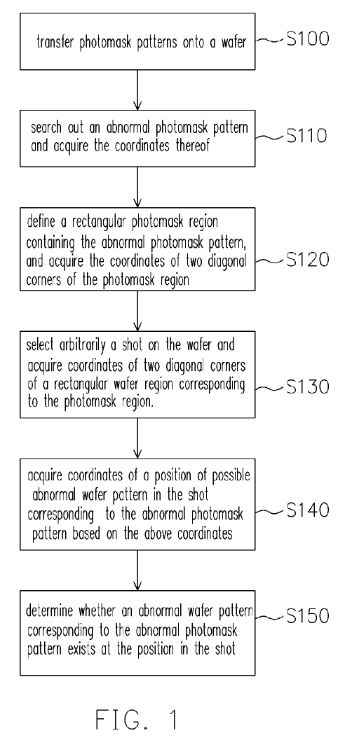

FIG. 1 is a flowchart showing a method for inspecting a photomask according to the first embodiment of this invention, wherein an abnormal photomask pattern is searched out and then it is determined whether a corresponding abnormal pattern exists on the wafer. As shown in FIG. 1, patterns on the photomask are transferred onto the wafer (S100), which can be carried out on a conventional exposure and developing devices. In other words, a photoresist layer may be formed on the wafer, patterns of the photomask can be projected in a transformation ratio on the wafer via an exposure device, and then, the undesirable portions of the photoresist layer are removed by using a developing devices.

Next, an abnormal pattern on the photomask is searched out, and the coordinates thereof are acquired (S110). A rectangular photomask region containing the abnormal pattern is defined, and the coordinates of two diagonal corner points of the photomask region are acquired (S120). The foregoing steps of S110 and S120 can be performed by using a conventional mask inspection tools, for example, the commonly used KLA-SLF27 machine, wherein the operating wavelength is 364 nm, and the patterns under the inspection can be displayed on a screen, so that the operator can acquire the coordinates of the abnormal photomask pattern, and then, define the diagonal photomask region and acquire the coordinates thereof. In addition, since the photomask region here is shown as a diagonal region, the area of which can be defined by the coordinates of two diagonal corner points.

Referring further to FIG. 1, a shot on the wafer is arbitrarily selected, and the coordinates of the two diagonal corner points of the rectangular wafer region corresponding to the photomask region are acquired (S130). Here, it is assumed that the shape of the patterns has not been changed in the process of pattern transferring from photomask to wafer, so that the wafer region corresponding to the rectangular photomask region is still of rectangular. Next, the coordinates of a position of possible abnormal pattern in the shot corresponding to the abnormal photomask pattern are calculated on the basis of the coordinates of the abnormal photomask pattern, the photomask region, and the wafer region (S140), and further, it is determined whether an abnormal wafer pattern corresponding to the abnormal photomask pattern exists at the foregoing position in the shot (S150). Wherein, the steps of S130 and S150 can be performed on a critical dimension scanning electron microscope (CD-SEM), and the scanned patterns can be displayed on the screen. Thus, the operator can determine the rectangular photomask region corresponding to the rectangular wafer region, acquires the coordinates of the rectangular photomask region for calculation and verification.

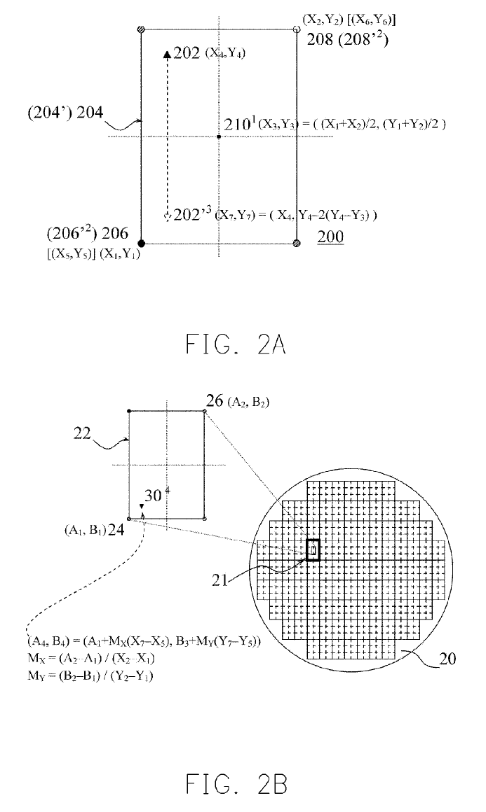

FIGS. 2A and 2B shows an example of the first embodiment. In this example, the exposure device generates a wafer pattern as a Y-axially inverted image of the photomask pattern. Note that, in this specification, the Y-axially inverted image is defined by an inversion in the direction of the Y-axis with respect to the center of the image, i.e., the inverted image is an upset-down image of the reference image as shown in the figures. The coordinates for the rectangular photomask/wafer regions are defined by the coordinates of the lower left corner and upper right corner of the corresponding regions.

As shown in FIG. 2A, the coordinate for the abnormal pattern 202 on the photomask 200 is (X₄,Y₄). The acquired coordinate of the lower left corner 206 of the photomask region 204 containing the abnormal pattern 202 is (X₁,Y₁), while the coordinate of the corresponding upper right corner is (X₂,Y₂). In addition, the coordinate of the lower left corner 24 of the corresponding wafer region 22 in the shot 21 selected on the wafer 20 is (A₁,B₁), while the coordinate of the upper right corner 26 is (A₂,B₂). Based on the coordinates of (X₄,Y₄), (X₁,Y₁), (X₂,Y₂), (A₁,B₁) and (A₂,B₂), the position of (A₄,B₄) for possible abnormal pattern 30 corresponding to the abnormal pattern 202 on the photomask 200 can be calculated. The method for the calculation is described as follows with reference to both FIGS. 2A and 2B.

First, the coordinate (X₃,Y₃) of the center 210 of the photomask region 204 is acquired, wherein X₃=(X₁+X₂)/2 and Y₃=(Y₁+Y₂)/2, and then, it is calculated to get the coordinate (X₅,Y₅) for the lower left corner 206′ of the Y-axially inverted image and the coordinate (X₆,Y₆) for the corresponding upper right corner 208′. The reason for performing such calculations is that, in this example, the photomask pattern is Y-axially inverted from the wafer pattern, and there is an assumption that no twist occurs in the photomask-wafer pattern transformation. Here, X₅=X₁, Y₅=Y₁, X₆=X₂, and Y₆=Y₂, since the Y-axially inverted image is superimposed with the original rectangular region. Next, it is calculated to obtain the coordinate of (X₇,Y₇) for the Y-axially inverted image 202′ of the abnormal patter 202, wherein X₇=X₄, and Y₇=Y₄−2(Y₄−Y₃). Here, the coordinate of the corner of the Y-axially inverted image region 204′ of the photomask region 204 is calculated from the coordinates of the Y-axially inverted image 202′ of the abnormal pattern 202, which is based on the Y-axial reversal relationship between the wafer pattern and the photomask pattern.

Next, it is calculated to obtain the X-axial conversion ratio for the photomask region 204 and the wafer region 22, M_{X}=(A₂−A₁)/(X₂−X₁), and the Y-axial conversion ratio, M_{Y}=(B₂−B₁)/(Y₂−Y₁). From the above, the coordinate (A4,B4) can be calculated, wherein A₄=A₁+M_{X}(X₇−X₅), and B₄=B₁+M_{Y}(Y₇-Y₅). By the way, the superscripts 1˜4 on 210, 206′, 208′, 202′ and 30 indicate the order in which the coordinates are acquired.

The above-mentioned conversions of the coordinates of the photomask-wafer regions are described as based on the lower left corner 206 of the photomask region 204 and the lower left corner 24 of the wafer region 22, however, the conversions can be also based on the corresponding upper right corners of the regions; which is merely a matter of the manner of calculation for the conversion.

### Second Embodiment

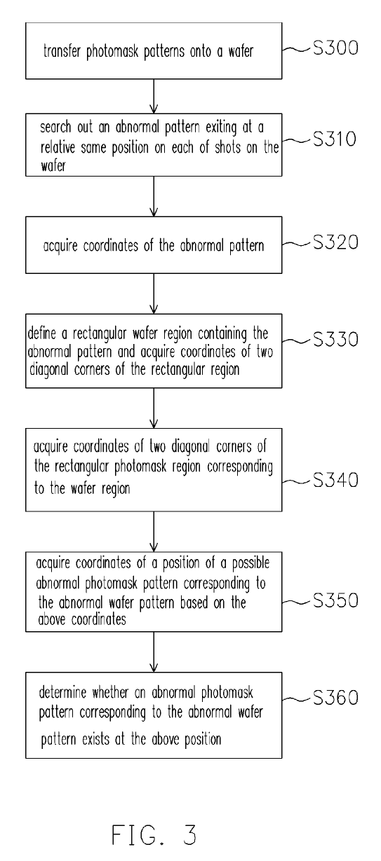

FIG. 3 is a flowchart showing a method for inspecting a photomask according the second embodiment of this invention, wherein an abnormal wafer pattern is searched and then it is determined whether a corresponding abnormal pattern exists on the photomask. First, patterns on the photomask are transferred onto the wafer (S300), as described in the first embodiment. Next, an abnormal pattern exiting at a same relative position on each of shots is searched out (S310), which can be achieved by using a conventional wafer inspection machine. Afterward, the coordinates of the abnormal pattern are acquired (S320), and then, a rectangular wafer region containing the abnormal pattern is defined and the coordinates of two diagonal corners of the rectangular region are acquired (S330). Wherein, the steps of S320 and S330 can be performed by using a CD-SEM.

Referring further to FIG. 3, the coordinates of two diagonal corners of the rectangular photomask region corresponding to the wafer region are obtained (S340). Here, it is assumed that there is no twist occurring in the photomask-wafer patterns transferring, and thus the photomask region is also of rectangular. A position of a possible abnormal photomask pattern corresponding to the abnormal wafer pattern is calculated on the basis of the coordinates of the abnormal wafer pattern, the wafer region, and the photomask region (S350). Further, it is determined whether an abnormal photomask pattern corresponding to the abnormal wafer pattern exists at the foregoing position. Wherein, the steps S340 and S360 can be performed by using a conventional mask inspection machine, such as the above-mentioned KLA-SLF27 machine.

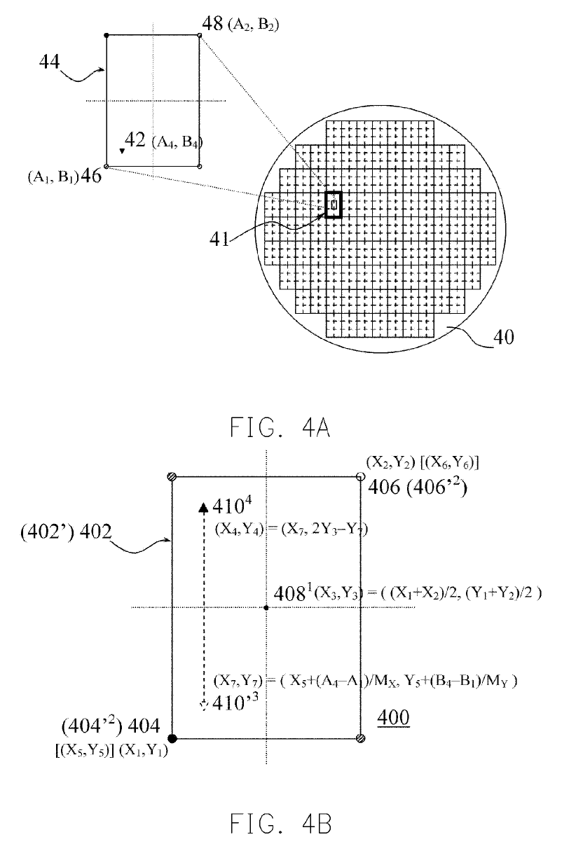

FIGS. 4A and 4B shows an example of the second embodiment. In this example, the exposure device generates a wafer pattern Y-axially inverted from the photomask pattern, and the acquired coordinates for the rectangular wafer and photomask regions are the coordinates of the lower left and the upper right corners of the regions.

As shown in FIG. 4A, the coordinate for the abnormal pattern 42 on the wafer 40 is (A₄,B₄). In an arbitrarily selected shot 41, the acquired coordinate of the lower left corner 46 of the wafer region 44 containing the abnormal pattern 42 is (A₁,B₁), while the coordinate of the corresponding upper right corner 48 is (A₂,B₂). In addition, the coordinate of the lower left corner 404 of the photomask region 402 corresponding to the wafer region 44 is (X₂,Y₂). Based on the coordinates of (A₄,B₄), (A₁,B₁), (A₂,B₂), (X₁,Y₁) and (X₂,Y₂), the coordinates (X₄,X₄) of the position of the possible abnormal pattern 410 in the photmask 402 corresponding to the abnormal pattern 42 on the wafer 40 can be calculated. The method for the calculation is described as follows with reference to both FIGS. 4A and 4B.

First, the coordinate for the center 408 of the photomask region 402 is acquired as (X₃,Y₃), wherein X₃=(X₁+X₂)/2 and Y₃=(Y₁+Y₂)/2, and then, it is calculated to get the coordinate (X₅,Y₅) for the lower left corner 404′ of the Y-axially inverted image 402′ of the photomask region 402 and the coordinates (X₆,Y₆) for the corresponding upper right corner 406′. The reason for performing such calculations is that, in this example, the photomask pattern is Y-axially inverted from the wafer pattern, and there is an assumption that no twist occurs in the photomask-wafer pattern transformation. Here, X₅=X₁, Y₅=Y₁, X₆=X₂, and Y₆=Y₂, since the Y-axially inverted image is superimposed with the original rectangular region. Next, it is calculated to obtain the conversion ratios for the photomask region 402 to the wafer region 44, wherein the X-axial conversion ratio is M_{X}=(A₂−A₁)/(X₂−X₁) and the Y-axial conversion ratio is M_{Y}=(B₂−B₁)/(Y₂−Y₁). It is then calculated to obtain the coordinate (X₇,Y₇) for the Y-axially inverted image 410′ of the abnormal pattern 410 in the photomask region 402, corresponding to the abnormal pattern 42 in the wafer region 44. Wherein, X₇=X₅+(A₄−A₁)/M_{X} and Y₇=Y₅+(B₄−B₁)/M_{Y}. Next, it is calculated to obtain the coordinate of (X₄,Y₄), wherein X₄=X₇ and Y₄=2Y₃−Y₇. Here, the coordinate of the Y-axially inverted imaage 410′ of the abnormal pattern 410 is calculated first because that the wafer pattern is inverted from the photomask pattern. By the way, the superscripts 1˜4 on 208, 404′, 406′, 410′ and 410 indicate the order in which the coordinates are acquired.

The above-mentioned conversions of the coordinates of the photomask-wafer regions are described as based on the lower left corner 46 of the wafer region 44 and the lower left corner 404 of the photomask region 402, however, the conversions can be also based on the corresponding upper right corners of the regions; which is merely a matter of the manner of calculation for the conversion.

In addition, the photomask regions and wafer regions in the foregoing embodiments are described as rectangular regions, but these regions can be also defined as other simple geographic shapes, such as circular and oval, so long as the area can be defined by relatively few coefficients.

As known from the above, the photomask inspection is carried out through conversion of photomask patterns to wafer patterns, so that conventional photomask inspection tools (such as KLA-SLF27 machine) available in semiconductor plants can be used for finding out possible abnormal patterns. Thus, the methods of this invention can be employed to significantly reduce the cost of photomask inspection, and is applicable in regular semiconductor plants. In addition, the methods of this invention can be used to determine whether the detected abnormal patterns affect the patterns on the wafer, or whether the abnormal patterns on the wafer are indeed caused by the photomask. Thus, the accuracy of the photomask inspection can be enhanced.

It will be apparent to those skilled in the art that various modifications and variations can be made to the methods of the present invention without departing from the scope or spirit of the invention. In view of the foregoing, it is intended that the present invention covers modifications and variations of this invention provided they fall within the scope of the following claims and their equivalents.

What is claimed is:

1. A method for inspecting a photomask, comprising:
(a) transferring patterns on the photomask onto a wafer;
(b) searching out an abnormal pattern on the photomask and acquiring coordinates of the abnormal pattern;
(c) defining a photomask region containing the abnormal pattern, and acquiring coordinates of the photomask region;
(d) selecting arbitrarily a shot on the wafer, and acquiring coordinates of a wafer region corresponding to the photomask region;
(e) acquiring coordinates of a position of a possible abnormal pattern in the shot corresponding to the abnormal pattern on the photomask, based on the coordinates of the abnormal pattern, the photomask region and the wafer region; and
(f) determining whether the position is of an abnormal pattern in the shot corresponding to the abnormal pattern on the photomask.

2. The method according to claim 1, wherein the steps (b) and (c) are performed by using a photomask-inspecting device.

3. The method according to claim 1, wherein the steps (d) and (f) are performed by using a critical dimension scanning electron microscope (CD-SEM).

4. The method according to claim 1, wherein both the photomask region and the corresponding wafer region are of rectangular.

5. The method according to claim 4, wherein the coordinates of the photomask region acquired in the step (c) are coordinates of two diagonal corners of the photomask region, and the coordinates of the wafer region acquired in the step (d) are coordinates of two diagonal corners of the wafer region.

6. The method according to claim 5, wherein coordinate of the abnormal pattern on the photomask is (X₄,Y₄), coordinates acquired in the step (c) include (X₁,Y₁) of the lower left corner of the photomask region and (X₂,Y₂) of the corresponding upper right corner, coordinates acquired in the step (d) include (A₁,B₁) of the lower left corner of the wafer region and (A₂,B₂) of the corresponding upper right corner, and the coordinate (A₄,B₄) of a position of a possible abnormal pattern in the wafer region is calculated on the basis of coordinates of (X₄,Y₄), (X₁,Y₁), (X₂,Y₂), (A₁,B₁) and (A₂,B₂).

7. The method according to claim 6, wherein the method of acquiring the coordinate (A₄,B₄) of the position of the possible abnormal pattern further comprises: acquiring coordinates (X₃,Y₃) of the center of the photomask region, wherein X₃=(X₁+X₂)/2 and Y₃=(Y₁+Y₂)/2;
acquiring coordinates (X₅,Y₅) of lower left corner and coordinates (X₆,Y₆) of upper right corner of a Y-axially inverted image of the photomask region, wherein X₅=X₁, Y₅=Y₁, X₆=X₂ and Y₆=Y₂, and the Y-axially inverted image is defined by an inversion in the direction of Y-axis with respect to the center of the image;
acquiring coordinates (X₇,Y₇) of a Y-axially inverted image of the abnormal pattern in the photomask region, wherein X₇=X₄ and Y₇=Y₄−2(Y₄−Y₃);
acquiring a X-axial transformation ratio M_{X}=(A₂−A₁)/(X₂−X₁) and a Y-axial transformation ratio M_{Y}=(B₂−B₁)/(Y₂−Y₁) of the rectangular photomask region versus the rectangular wafer region; and
acquiring coordinates (A4,B4), wherein A₄=A₁+M_{X}(X₇−X₅) and B₄=B₁+M_{Y}(Y₇−Y₅).

8. A method for inspecting a photomask, comprising:
(a) transferring patterns on the photomask onto a wafer;
(b) searching out an abnormal pattern on the wafer and acquiring coordinate (X₄,Y₄) of the abnormal pattern;
(c) defining a rectangular photomask region containing the abnormal pattern, and acquiring coordinates of two diagonal corners of the rectangular photomask region, the coordinates being (X₁,Y₁) of the lower left corner and (X₂,Y₂) of the upper right corner of the rectangular photomask region;
(d) selecting arbitrarily a shot on the wafer, and acquiring coordinates of two diagonal corners of a rectrangular wafer region in the shot, the rectangular wafer region corresponding to the rectangular photomask region, and the coordinates being (A₁,B₁) of the lower left corner and (A₂,B₂) of the upper right corner of the rectangular wafer region;
(e) acquiring coordinate (A₄,B₄) of a position of a possible abnormal pattern in the shot corresponding to the abnormal pattern on the photomask, based on the coordinates of (X₄,Y₄), (X₁,Y₁), (X₂,Y₂), (A₁,B₁) and (A₂,B₂); and
(f) determining whether the position in the shot is of an abnormal pattern in the shot corresponding to the abnormal pattern on the photomask,
wherein, the step (e) comprising:
acquiring coordinate (X₃,Y₃) of the center of the rectangular photomask region, wherein X₃=(X₁+X₂)/2 and Y₃=(Y₁+Y₂)/2;
acquiring coordinates (X₅,Y₅) of the lower left corner and (X₆,Y₆) of the upper right corner of a Y-axially inverted image of the rectangular photomask region, wherein X₅=X₁, Y₅=Y₁, X₆=X₂ and Y₆=Y₂;
acquiring coordinates (X₇,Y₇) of a Y-axially inverted image of the abnormal pattern in the rectangular photomask region, wherein X₇=X₄ and Y₇=Y₄−2(Y₄−Y₃);
acquiring X-axis transformation ratio M_{X}=(A₂−A₁)/(X₂−X₁) and Y-axis transformation ratio M_{Y}=(B₂−B₁)/(Y₂−Y₁) of the rectangular photomask region versus the rectangular wafer region; and
acquiring coordinate (A4,B4), wherein A₄=A₁+M_{X}(X₇−X₅) and B₄=B₁+M_{Y}(Y₇−Y₅).

9. The method according to claim 8, wherein the steps (b) and (c) are performed by using a photomask-inspecting device.

10. The method according to claim 8, wherein the steps (d) and (f) are performed by using a critical dimension scanning electron microscope (CD-SEM).

11. A method for inspecting a photomask, comprising:
(a) transferring a pattern on the photomask onto a wafer;
(b) searching out an abnormal pattern existing at a same relative position of a plurality of shots on the wafer;
(c) acquiring coordinates of the position of the abnormal pattern;
(d) defining a wafer region containing the abnormal pattern, and acquiring coordinates of the wafer region;
(e) acquiring coordinates of a photomask region on the photomask corresponding to the wafer region;
(f) acquiring coordinates of a position of a possible abnormal pattern on the photomask corresponding to the abnormal pattern on the wafer, based on the coordinates of the abnormal pattern, the coordinates of the wafer region and the coordinates of the photomask region; and
(g) determining whether the position is of an abnormal pattern on the photomask corresponding to the abnormal pattern on the wafer.

12. The method according to claim 11, wherein the step (b) are performed by using a wafer-inspecting device.

13. The method according to claim 11, wherein the steps (c) and (d) are performed by using a CD-SEM.

14. The method according to claim 11, wherein the steps (e) and (g) are performed by using a photomask-inspecting device.

15. The method according to claim 11, wherein both the wafer region and the corresponding photomask region are of rectangular.

16. The method according to claim 15, wherein the coordinates of the wafer region acquired in the step (d) are coordinates of two diagonal corners of the wafer region, and the coordinates of the photomask region acquired in the step (e) are coordinates of two diagonal corners of the photomask region.

17. The method according to claim 16, wherein the coordinates of the abnormal pattern on the wafer are (A₄,B₄), the coordinates acquired in the step (d) for the lower left corner and the upper right corner of the wafer region are respectively (A₁,B₁) and (A₂,B₂), the coordinates acquired in the step (e) for the lower left corner and the upper right corner of the photomask region are respectively (X₁,Y₁) and (X₂,Y₂), and the coordinates of the position of the possible abnormal pattern in the photomask region is calculated on the basis of coordinates of (A₄,B₄), (A₁,B₁), (A₂,B₂), (X₁,Y₁) and (X₂,Y₂).

18. The method according to claim 17, wherein the method of acquiring the coordinate (A₄,B₄) of the position of the possible abnormal pattern further comprises:
acquiring coordinate (X₃,Y₃) of the center of the photomask region, wherein X₃=(X₁+X₂)/2 and Y₃=(Y₁+Y₂)/2;
acquiring coordinates (X₅,Y₅) of lower left corner and coordinates (X₆,Y₆) of upper right corner of a Y-axially inverted image of the photomask region, wherein X₅=X₁, Y₅=Y₁, X₆=X₂ and Y₆=Y₂, and the Y-axially inverted image is defined by an inversion in the direction of Y-axis with respect to the center of the image;
acquiring a X-axial transformation ratio M_{X}=(A₂−A₁)/(X₂−X₁) and a Y-axial transformation ratio M_{Y}=(B₂−B₁)/(Y₂−Y₁) of the rectangular photomask region versus the rectangular wafer region;
acquiring coordinates (X₇,Y₇) of a Y-axially inverted image of the possible abnormal pattern in the photomask region corresponding to the abnormal pattern on the wafer, wherein X₇=X₅+(A₄−A₁)/M_{X} and Y₇=Y₅+(B₄−B₁)/M_{Y}; and
acquiring X₄ and Y₄, wherein X₄=X₇ and Y₄=2Y₃−Y₇.

19. A method for inspecting a photomask, comprising:
(a) transferring a pattern on the photomask onto a wafer;
(b) searching out an abnormal pattern existing at a same relative position of a plurality of shots on the wafer;
(c) acquiring coordinate (A₄,B₄) of the position of the abnormal pattern;
(d) defining a rectangular wafer region containing the abnormal pattern, and acquiring coordinates of two diagonal corners of the wafer region, the coordinates including (A₁,B₁) of the lower left corner and (A₂,B₂) of the upper right corner of the wafer region;
(e) acquiring coordinates of two diagonal corners of a rectangular photomask region on the photomask corresponding to the wafer region, the coordinates including (X₁,Y₁) of the lower left corner and (X₂,Y₂) of the upper right corner of the photomask region;
(f) acquiring coordinate (X₄,Y₄) of a position of a possible abnormal pattern on the photomask corresponding to the abnormal pattern on the wafer, based on the coordinates of (A₄,B₄), (A₁,B₁), (A₂,B₂), (X₁,Y₁) and (X₂,Y₂); and
(g) determining whether the position is of an abnormal pattern on the photomask corresponding to the abnormal pattern on the wafer,
wherein, the step (f) comprising:
acquiring coordinate (X₃,Y₃) of the center of the rectangular photomask region, wherein X₃=(X₁+X₂)/2 and Y₃=(Y₁+Y₂)/2;
acquiring coordinates (X₅,Y₅) of the lower left corner and (X₆,Y₆) of the upper right corner of a Y-axially inverted image of the rectangular photomask region, wherein X₅=X₁, Y₅=Y₁, X₆=X₂ and Y₆=Y₂;
acquiring X-axis transformation ratio M_{X}=(A₂−A₁)/(X₂−X₁) and Y-axis transformation ratio M_{Y}=(B₂−B₁)/(Y₂−Y₁) of the rectangular photomask region versus the rectangular wafer region;
acquiring coordinate (X₇,Y₇) of a Y-axially inverted image of the possible abnormal pattern in the photomask region corresponding to the abnormal pattern on the wafer, wherein X₇=X₅+(A₄−A₁)/M_{X} and Y₇=Y₅+(B₄−B₁)/M_{Y}; and
acquiring coordinate (A4,B4), wherein X₄=X₇ and Y₄=2Y₃−Y₇.

20. The method according to claim 19, wherein the step (b) is performed by using a wafer-inspecting device.

21. The method according to claim 19, wherein the steps (c) and (d) are performed by using a CD-SEM.

22. The method according to claim 19, wherein the steps (e) and (g) are performed by using a photomask-inspecting device.
